(19) United States
(12) Patent Application Publication
(10) Pub. No.: US 2017/0026359 A1
(43) Pub. Date: Jan. 26, 2017

(54) DATA PROVISION SYSTEM

(71) Applicant: Ikumi ARAKANE, Kanagawa (JP)

(72) Inventor: Ikumi ARAKANE, Kanagawa (JP)

(21) Appl. No.: 15/006,741

(22) Filed: Jan. 26, 2016

(30) Foreign Application Priority Data
Jul. 20, 2015 (JP) 2015-143529

(51) Int. Cl. H04L 29/06; G06Q 10/06

(52) U.S. Cl. CPC H04L 63/083; G06Q 10/067

(57) ABSTRACT

A data provision system includes: a certification issuing unit that transmits business entity certification to a business entity system; a password issuing unit that transmits a password to a user terminal in response to a password issuing request from the user terminal; a validity checking unit that checks validity of the business entity certification and the password transmitted from the business entity system; a personal information requesting unit that requests the user terminal to transmit personal information to the data provision system when the business entity certification and the password are valid; and a personal information transmitting unit that transmits, to the business entity system, the personal information transmitted from the user terminal.

### CROSS-REFERENCE TO RELATED APPLICATION

This application claims priority from Japanese Patent Application No. 2015-143529 filed with the Japan Patent Office on Jul. 20, 2015, the entire content of which is hereby incorporated by reference.

### BACKGROUND

1. Technical Field

The present disclosure relates to a data provision system.

2. Description of the Related Art

In recent years, more and more people do business through the Internet and such business is highly convenient for users. In many cases, however, the pieces of personal information including name, address, telephone number, and credit card number are transmitted to the business entity that provides the service through the Internet.

The personal information is so useful that one may suffer a disadvantage if his/her personal information is known by a malicious party. On the other hand, from the perspective of the business entities (especially, enterprises) that have received the personal information from individuals, the leakage of the personal information of the individuals as the clients can have a lame adverse influence on their business. For these reasons, the business entities have made various countermeasures to protect the personal information.

According to the information provision system disclosed in JP-A-2009-157676, a service user (individual) is informed through his/her terminal if the disclosure of his/her personal information is requested. Moreover, the service user is requested to determine whether to disclose the information or not.

### SUMMARY

A data provision system includes: a certification issuing unit that transmits business entity certification to a business entity system; a password issuing unit that transmits a password to a user terminal in response to a password issuing request from the user terminal; a validity checking unit that checks validity of the business entity certification and the password transmitted from the business entity system; a personal information requesting unit that requests the user terminal to transmit personal information to the data provision system when the business entity certification and the password are valid; and a personal information transmitting unit that transmits, to the business entity system, the personal information transmitted from the user terminal.

### BRIEF DESCRIPTION OF THE DRAWINGS

FIG. 1 is a schematic diagram illustrating a data provision system and a process performed thereby; and

FIG. 2 is a flowchart illustrating the process of a validity checking unit.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the information provision system according to JP-A-2009-157676, the personal information provided from the service users is left in the personal information DB. Therefore, the service provider remains at the leakage risk of the personal information. For dealing with the leakage risk, the service provider needs to make an investment as appropriate. In the perspective of cost, the service providers, especially the small-scaled service providers, find it difficult to use the system.

An object of the present disclosure is to provide a data provision system as below. This data provision system can protect the personal information and can be used at low cost by a business entity that acquires the personal information. Moreover, this data provision system can minimize the leakage risk of the personal information of the service users.

(1) A data provision system of a first aspect of the present disclosure includes: a certification issuing unit that transmits business entity certification to a business entity system; a password issuing unit that transmits a password to a user terminal in response to a password issuing request from the user terminal; a validity checking unit that checks validity of the business entity certification and the password transmitted from the business entity system; a personal information requesting unit that requests the user terminal to transmit personal information to the data provision system when the business entity certification and the password are valid; and a personal information transmitting unit that transmits, to the business entity system, the personal information transmitted from the user terminal.

(2) In the data provision system of a second aspect of the present disclosure according to the data provision system of the first aspect, the certification issuing unit transmitting the business entity certification to the business entity system in response to a request from the business entity system.

(3) In the data provision system of a third aspect of the present disclosure according to the data provision system of the first or second aspect, the validity checking unit invalidates the business entity certification and the password when a predetermined period of time set for each of the business entity certification and the password has passed. The validity checking unit has a function of notifying an error to one of or both the business entity system and the user terminal when any of the business entity certification and the password is invalid.

(4) In the data provision system of a fourth aspect of the present disclosure according to the data provision system of any of the first to third aspects, the personal information transmitting unit deletes the personal information from the data provision system when a predetermined period of time has passed after the personal information is transmitted to the business entity system.

(5) In the data provision system of a fifth aspect of the present disclosure according to any of the first to fourth aspects, the personal information transmitting unit needs approval from the user terminal when the personal information is transmitted from the data provision system to the business entity system.

In the data provision system according to the first aspect, if the business entity certification and the password are valid, the personal information is transmitted from the user terminal to the business entity system. Therefore, the careless leakage of the personal information can be suppressed.

In the data provision system according to the second aspect, the business entity certification is transmitted every time the business entity needs the certification. Therefore, the business entity certification can be used like a one-time password. As a result, the protection of the personal information can be enhanced.

In the data provision system according to the third aspect, the business entity certification or the password after a certain period of time or more has passed is considered to have some kind of trouble, so that in this case, the personal information is not transmitted to the business entity system. This can reduce the risk of the intervention of a third party with the malicious intension.

In the data provision system according to the fourth aspect, the personal information is deleted from the data provision system after a predetermined period of time has passed. Therefore, the data provision system does not need to maintain the personal information. As a result, the leakage risk of the personal information can be avoided.

In the data provision system according to the fifth aspect, the user who operates the user terminal determines finally whether to transmit his/her personal information. Thus, the risk of erroneously transmitting the personal information due to the operation mistake or the like can be reduced.

A preferred embodiment of the present disclosure is described below with reference to the attached drawings. The embodiment is merely an example for helping the understanding of the technique disclosed herein and will not limit the technique according to the present disclosure unless otherwise stated. Throughout the specification and the drawings, the components with substantially the same function and/or the same structure are given the same symbol and the overlapping description is omitted. The components that are not directly relevant to the technique according to the present disclosure are not illustrated.

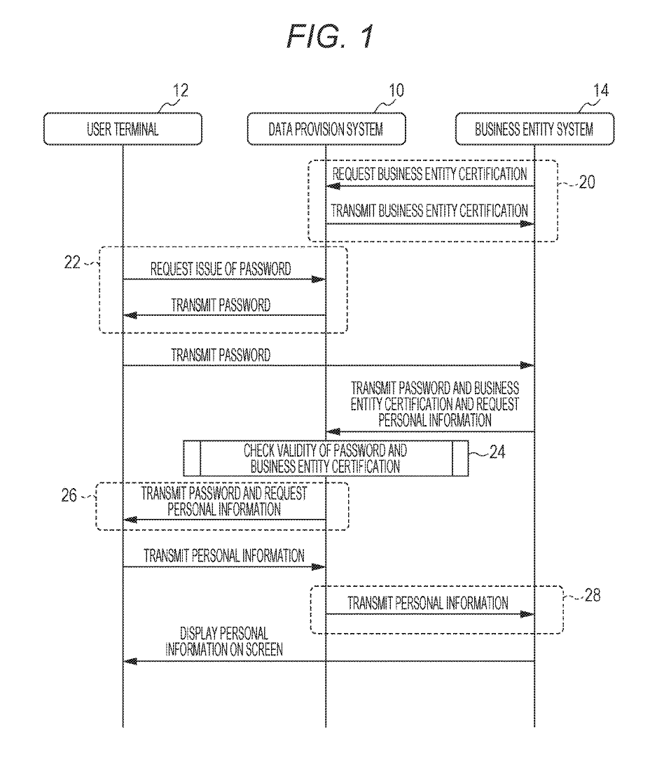

FIG. 1 is a schematic diagram illustrating a data provision system 10 and a process performed thereby. With reference to FIG. 1, the data provision system 10 is described.

The data provision system 10 can communicate with a user terminal 12 having a display screen and a business entity system 14 through a line. The user terminal 12 is operated by a user who uses the service of the business entity system 14. The business entity system 14 is a system run by a business entity that provides the service. The user terminal 12 stores the user's personal information that is needed to use the service provided by the business entity.

The data provision system 10 includes a certification issuing unit 20, a password issuing unit 22, a validity checking unit 24, a personal information requesting unit 26, and a personal information transmitting unit 28. These units perform the process sequentially.

Next, the operation of the data provision system 10 is described.

First, the business entity that provides the service operates the business entity system 14 to request the business entity certification to the data provision system 10. In the data provision system 10, the certification issuing unit 20 transmits (issues) business entity certification to the business entity system 14 in response to the request from the business entity system 14. In this case, the business entity certification may be valid for a certain period of time after the transmission, or valid only once like a one-time password. The period where the business entity certification is valid can be set arbitrarily by the data provision system 10.

Next, the user who would like to use the service provided by the business entity operates the user terminal 12 to request the data provision system 10 to issue a password. In the data provision system 10, the password issuing unit 22 transmits (issues) the password to the user terminal 12 in response to the issuing request from the user terminal 12. The password may be a character string or something like an image. In short, the password may be anything that a third party cannot easily guess.

The user operates the user terminal 12 to transmit the password, which has been transmitted from the data provision system 10, to the business entity system 14 run by the business entity that provides the user's desired service.

The business entity system 14 transmits the password transmitted from the user terminal 12 and the business entity certification transmitted from the data provision system 10, together to the data provision system 10. Additionally, the business entity system 14 requests, to the data provision system 10, the personal information of the user who operates the user terminal 12.

When the data provision system 10 receives the password and the business entity certification from the business entity system 14, the validity checking unit 24 of the data provision system 10 checks the validity of the password and the business entity certification.

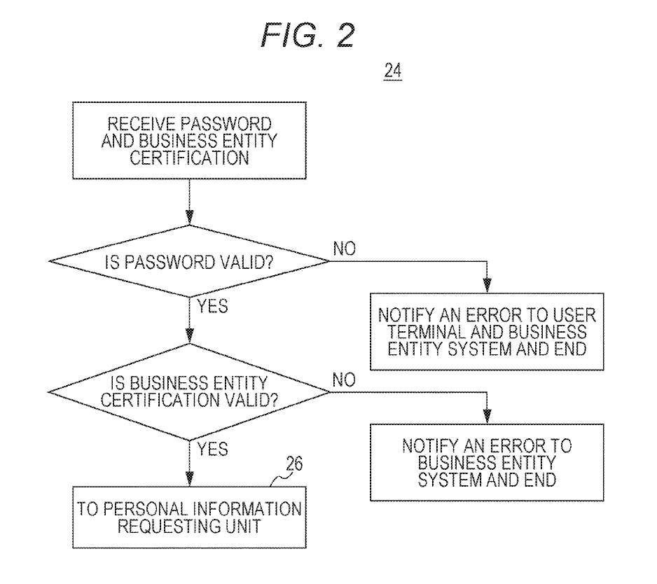

FIG. 2 is a flowchart of the process of the validity checking unit 24.

Description is hereinafter made of the process of checking the validity with reference to FIG. 2.

After the business entity system 14 receives the password and the business entity certification, the validity checking unit 24 checks the validity of the password. In this checking process, the validity checking unit 24 checks if the received password coincides with the password transmitted to the user terminal 12 from the password issuing unit 22. Moreover, the validity checking unit 24 preferably checks if the password has been received within a predetermined period of time.

If the password is not valid, the validity checking unit 24 notifies an error to the user terminal 12 and the business entity system 14, and ends the process.

If the password is valid, the validity checking unit 24 next checks the validity of the business entity certification. In a manner similar to the checking of the password, the validity checking unit 24 checks if the received business entity certification coincides with the business entity certification, which has been transmitted to the business entity system 14 by the certification issuing unit 20. Moreover, the validity checking unit 24 preferably checks if the business entity certification has been received within a predetermined period of time.

If the business entity certification is not valid, the validity checking unit 24 notifies an error to the business entity system 14, and ends the process. Note that if a predetermined period of time set to the password has passed after the transmission (issue) of the password, the validity checking unit 24 may invalidate the password. Similarly, if a predetermined period of time set to the business entity certification has passed after the transmission (issue) of the business entity certification, the validity checking unit 24 may invalidate the business entity certification. If the business entity certification or the password is invalid, the validity checking unit 24 may notify an error to one of or both the business entity system 14 and the user terminal 12.

If both the password and the business entity certification are valid, the validity checking unit 24 transfers the process to the personal infortnation requesting unit 26 and ends the process.

As shown in FIG. 1, the personal information requesting unit 26 that has taken over the process from the validity checking unit 24 requests the user terminal 12 to transmit the personal information to the data provision system 10. When requesting the user terminal 12 to transmit the personal information, the personal information requesting unit 26 may transmit the password, which is the same as the password already transmitted to the user terminal 12, to the user terminal 12.

The user terminal 12 transmits the personal information, which has been requested by the personal information requesting unit 26, to the data provision system 10. Here, the user terminal 12 may be set to transmit the personal information to the data provision system 10 only after it has been confirmed that the password transmitted from the personal information requesting unit 26 coincides with the password transmitted from the password issuing unit 22.

In the data provision system 10, the personal information transmitting unit 28 transmits the personal information, which has been received from the user terminal 12, to the business entity system 14. In order to obtain the approval from the user for the transmission of the personal information before the personal information is transmitted to the business entity system 14, the personal information transmitting unit 28 may display the choices to permit or not to permit the transmission of the personal information on the display screen of the user terminal 12 so the user can make a choice. In this case, the personal information transmitting unit 28 may transmit the personal information to the business entity system 14 after obtaining the user's approval for the transmission through the user terminal 12. That is to say, the personal information transmitting unit 28 may need the approval from the user terminal 12 before the data provision system 10 transmits the personal information to the business entity system 14.

The business entity system 14 having received the personal information displays the received personal information on the screen of the user terminal 12.

The data provision system 10 and the business entity system 14 delete the personal information transmitted from the user terminal 12 from the systems when the predetermined period of time has passed or at the point in time when the personal information becomes unnecessary. For example, the personal information transmitting unit 28 erases the personal information from the data provision system 10 when the predetermined period of time has passed after the personal information is transmitted to the business entity system 14.

Such a series of processes of the data provision system 10 minimizes the amount of personal information held in the data provision system 10 and the business entity system 14. This can minimize the leakage risk of the personal information. The user transmits his/her personal information every time it is necessary. Therefore, the user can know which business entity has his/her personal information. Thus, the user can reduce the risk of the spread of his/her personal information.

The preferred embodiment of the present disclosure has been described so far with reference to the attached drawings.

It is apparent that a person skilled in the art can conceive various changes and modifications within the range according to the scope of claims. Therefore, it is understood that such changes and modifications belong to the technical range according to the present disclosure.

The technique according to the embodiment of the present disclosure may be used as the data provision system as below. The data provision system can protect the useful information such as the personal information, and reduce the burden on the business entity that acquires the personal information in regard to the use of the personal information.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A data provision system comprising:
a certification issuing unit that transmits business entity certification to a business entity system;
a password issuing unit that transmits a password to a user terminal in response to a password issuing request from the user terminal;
a validity checking unit that checks validity of the business entity certification and the password transmitted from the business entity system;
a personal information requesting unit that requests the user terminal to transmit personal information to the data provision system when the business entity certification and the password are valid; and
a personal information transmitting unit that transmits, to the business entity system, the personal information transmitted from the user terminal.

2. The data provision system according to claim 1, wherein
the certification issuing unit transmits the business entity certification to the business entity system in response to a request from the business entity system.

3. The data provision system according to claim 1, wherein
the validity checking unit invalidates the business entity certification and the password when a predetermined period of time set for each of the business entity certification and the password has passed, and
the validity checking unit has a function of notifying an error to one of or both the business entity system and the user terminal when any of the business entity certification and the password is invalid.

4. The data provision system according to claim 2, wherein
the validity checking unit invalidates the business entity certification and the password when a predetermined period of time set for each of the business entity certification and the password has passed, and
the validity checking unit has a function of notifying an error to one of or both the business entity system and the user terminal when any of the business entity certification and the password is invalid.

5. The data provision system according to claim 1, wherein
the personal information transmitting unit deletes the personal information from the data provision system when a predetermined period of time has passed after the personal information is transmitted to the business entity system.

6. The data provision system according to claim 2, wherein
the personal information transmitting unit deletes the personal information from the data provision system when a predetermined period of time has passed after the personal information is transmitted to the business entity system.

7. The data provision system according to claim 3, wherein
the personal information transmitting unit deletes the personal information from the data provision system when a predetermined period of time has passed after the personal information is transmitted to the business entity system.

8. The data provision system according to claim 4, wherein
the personal information transmitting unit deletes the personal information from the data provision system when a predetermined period of time has passed after the personal information is transmitted to the business entity system.

9. The data provision system according to claim 1, wherein
the personal information transmitting unit needs approval from the user terminal when the personal information is transmitted from the data provision system to the business entity system.

10. The data provision system according to claim 2, wherein
the personal information transmitting unit needs approval from the user terminal when the personal information is transmitted from the data provision system to the business entity system.

11. The data provision system according to claim 3, wherein
the personal information transmitting unit needs approval from the user terminal when the personal information is transmitted from the data provision system to the business entity system.

12. The data provision system according to claim 4, wherein
the personal information transmitting unit needs approval from the user terminal when the personal information is transmitted from the data provision system to the business entity system.

13. The data provision system according to claim 5, wherein
the personal information transmitting unit needs approval from the user terminal when the personal information is transmitted from the data provision system to the business entity system.

14. The data provision system according to claim 6, wherein
the personal information transmitting unit needs approval from the user terminal when the personal information is transmitted from the data provision system to the business entity system.

15. The data provision system according to claim 7, wherein
the personal information transmitting unit needs approval from the user terminal when the personal information is transmitted from the data provision system to the business entity system.

16. The data provision system according to claim 8, wherein
the personal information transmitting unit needs approval from the user terminal when the personal information is transmitted from the data provision system to the business entity system.
